(19) United States
(12) Patent Application Publication
(10) Pub. No.: US 2006/0010743 A1
(43) Pub. Date: Jan. 19, 2006

(54) Adhesive shelf talker

(76) Inventors: Richard D. Fowler, Frisco, TX (US); Ted R. Taylor, Arlington, TX (US)

Correspondence Address: SHERIDAN ROSS PC, 1560 BROADWAY, SUITE 1200, DENVER, CO, 80202, US

(21) Appl. No.: 11/195,097

(22) Filed: Aug. 1, 2005

Related U.S. Application Data
(62) Division of application No. 10/666,420, filed on Sep. 19, 2003.

(51) Int. Cl. G09F 3/10

(52) U.S. Cl. 40/638; 40/661.03

(57) ABSTRACT

An adhesive shelf talker is provided with upper and lower end portions that are selectively separable from one another. The upper end portion provides non-promotional product information, while the lower end portion provides the promotional information for the product. A two-part release liner is provided so that the upper end portion may adhere to a shelf edge while leaving the lower end portion of the shelf talker, which hangs below the shelf, unexposed.

### BACKGROUND OF THE INVENTION

The present invention relates to point-of-purchase product identification labels, and more particularly to a shelf talker having a selectively detachable portion for the removal of information that is no longer applicable to the product being identified.

### DESCRIPTION OF THE PRIOR ART

Point-of-purchase labels are frequently secured to the forward edge portion of product shelves in order to promote the product's brand identity, units of measure and price. Shelf talkers are a special type of point-of-purchase label that are typically used for price comparisons, discount prices and various promotions. Typically, the shelf talker is larger than the permanent product label affixed to the edge of the shelf and extends outwardly from the shelf in some manner to increase the visibility of the product being promoted. When the promotion is over, the shelf talker is removed, and a permanent product label is put in its place.

While the use of shelf talkers has become popular for identifying promotional products, prior art shelf talkers suffer from a number of drawbacks. First, the use of a permanent product label and a separate shelf talker doubles the number of point-of-purchase labels that must be prepared and secured to the edge of the shelf. Some prior art shelf talkers must also be configured with specialized structures that allow the shelf talker to be temporarily hung from the shelf without interference with the permanent product label. An example of one such shelf talker is disclosed within U.S. Pat. No. 6,408,553, which teaches a shelf talker that is temporarily secured to a shelf bracket using an adhesive strip and specially constructed bracket engagement lips, which secure the shelf talker in place.

Accordingly, typical methods of identifying certain products that are later placed on a special promotion require a permanent label to be prepared and a certain amount of labor to install the label on the edge of the shelf. When the promotion is initiated, the separate shelf talker must be prepared; and again, labor must be expended to remove the permanent product label and secure the shelf talker in its place. Once the promotion for the product is over, additional labor must be expended to remove the shelf talker, prepare a new permanent label and secure it to the shelf. While the amount of money, materials and labor involved in this process are fairly insignificant for any one product, these unnecessary expenditures add up when hundreds of different products need identification in a single store. This may occur several times in a single year and in many stores across the country, in the case of a national chain.

Accordingly, what is needed is a shelf talker that is able to provide both the permanent product label and a separable promotional information portion to help reduce the expenditure of materials and labor in the identification and promotion of a product.

### SUMMARY OF THE INVENTION

The shelf talker of the present invention is generally provided with a label sheet having upper and lower end portions that are selectively separable from one another. The upper end portion is preferably provided with product information typically found on permanent product labels. The lower end portion is provided with product information typically relating to time-sensitive promotions of the product. A pressure-sensitive adhesive is provided along the back side of the label sheet. A liner sheet is bonded to the adhesive and the back side of the label sheet.

When the label sheet is separated from the liner sheet, the upper end portion of the label sheet can be secured to the edge portion of the shelf beneath the product being identified, which leaves the lower end portion of the label sheet to hang beneath the edge of the shelf. Upon completion of the promotion, the lower end portion of the label sheet can be quickly and easily removed from the upper end portion of the label sheet, leaving the same behind as a permanent product label. In a preferred embodiment, a portion of the liner sheet remains coupled to the back side of the lower end portion of the label sheet, substantially covering the same.

In a preferred method of making the shelf talker of the present invention, a repositional adhesive is used to allow the shelf talker to be adjusted and easily removed when necessary. A lightweight non-curl liner is preferably used, which lends itself to continuous form, fanfold, roll or separate sheet end product, depending on the printing application desired. A preferred method of printing the product information onto the label sheet may utilize impact, laser, thermal imaging and other imaging technologies to assist in reducing the cost of the end product.

It is therefore one of the principal objects of the present invention to provide a two-part shelf talker that provides both a permanent product label and a separable promotional information portion.

A further object of the present invention is to provide a shelf talker that reduces the total materials and labor used to identify and promote products at a point of sale.

Yet another object of the present invention is to provide a shelf talker having a two-part liner sheet for use with a separable promotional information portion.

Still another object of the present invention is to provide a shelf talker that is constructed using a lightweight, non-curl liner.

A further object of the present invention is to provide a shelf talker that is simple in construction and use.

Yet another object of the present invention is to provide a shelf talker that greatly reduces the time spent implementing shelf talker-style product promotion.

These and other objects of the present invention will be apparent to those of skill in the art.

### BRIEF DESCRIPTION OF THE DRAWINGS

FIG. 1 is a perspective view of one embodiment of the adhesive shelf talker of the present invention as the same may be prepared along with a plurality of adhesive shelf talkers on a single liner sheet;

FIG. 2A is a forward perspective view of one embodiment of the adhesive shelf talker of the present invention;

FIG. 2B is a rearward perspective view of the adhesive shelf talker of FIG. 2A; and

FIG. 3 is a perspective view of the adhesive shelf talker of FIG. 2A as the same could be used to identify products on a shelf display.

### DESCRIPTION OF THE PREFERRED EMBODIMENT

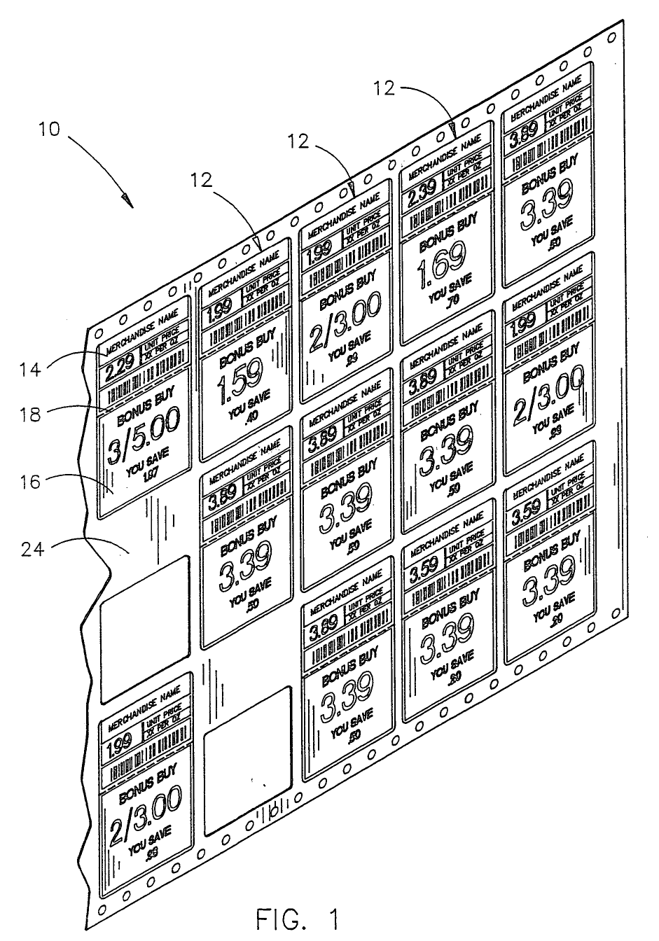

The adhesive shelf talker 10 of the present invention is generally depicted in FIGS. 1-3. In its preferred embodiment, the adhesive shelf talker 10 is generally provided with a label sheet 12 having an upper end portion 14 and a lower end portion 16. In one embodiment, which is described more fully hereinbelow, the label sheet 12 is provided with a line of weakness 18 that extends across the width of the label sheet 12 in a generally perpendicular fashion. The line of weakness 18 may be formed in one of several ways, including microperforations, die cuts, or the like. The line of weakness 18 permits the selective separation of the upper end portion 14 from the lower end portion 16. In a preferred embodiment, the label sheet 12 is preferably constructed from a lightweight, non-curl liner, including, but not limited to, monomeric vinyl, polymeric vinyl, biaxally-oriented polypropylene, and the like.

The label sheet 12 has a forward surface 20 and a rearward surface 22. The forward surface 20 is adapted for receiving printed indicia thereon, relating to the products that the adhesive shelf talker 10 will be promoting. In one embodiment, it is contemplated that the upper end portion 14 of the label sheet 12 will be provided with information relating to the identity of the product's brand, its units of measure, and the price of the product. Other information may certainly be included; however, it is contemplated that this information will typically relate to that information which would be commonly found on permanent product labels in a retail display setting. In this same embodiment, the lower end portion 16 of the label sheet 12 will be provided with time- or event-sensitive information, such as price comparisons, discount prices, manager's promotions, and the like. Again, it is contemplated that virtually any indicia could be provided to the lower end portion 16 as the specific needs present themselves.

The rearward surface 22 of the label sheet 12 is preferably provided with a pressure-sensitive adhesive. Although many different types of adhesive could be used in the present application, it is contemplated that preferred embodiments may incorporate one of a removable acrylic emulsion, cold temperature acrylic emulsion, a permanent acrylic emulsion, or other similar variations thereof. The adhesive selected will depend upon the particular application desired. For example, permanent adhesion may be desired in one setting, whereas a repositional adhesive may be more desirable in those use settings which may require the adjustment or moving of the adhesive shelf talker 10.

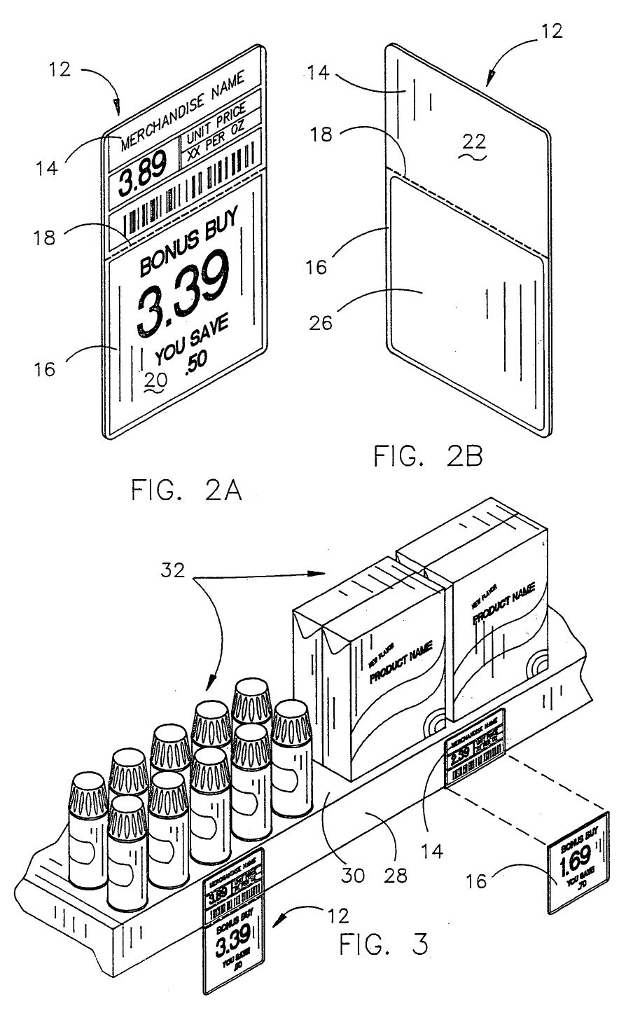

A liner sheet 24 is generally coupled with the adhesive laden rearward surface 22 of the label sheet 12. Several different liner materials could be incorporated within any of the embodiments of the present invention, including, but not limited to, Super Calandered Kraft, machine-finished, poly-coated, lay flat, or the like. In one preferred embodiment, a series of back cuts or other lines of weakness are provided into the liner sheet 24 directly behind the lower end portion 16 of the label sheet 12. Preferably, these back cuts will form a closed shape that is similar in size and shape to the lower end portion 16. An example is depicted in FIG. 2B. The series of back cuts provide a secondary liner 26, which is selectively removable from the liner sheet 24 when the label sheet 12 is removed from the liner sheet 24. The secondary liner 26 depicted in FIG. 2B is shown having a preferred size relationship with the lower end portion 16 of the label sheet 12 wherein a small perimeter edge portion of the lower end portion 16 is left uncovered by the secondary liner 26. This small peripheral edge portion is preferably coated in the adhesive that coats the rearward surface 22, and thus assists in securing the lower end portion 16 of the label sheet 12 to the liner sheet 24 until the label sheet 12 is selectively removed therefrom. However, it is contemplated that the secondary liner 26 could be provided in nearly any shape and size compared to the lower end portion 16 of the label sheet 12. For example, a larger or smaller peripheral edge portion of the lower end portion 16 could be left exposed by the secondary liner 26, depending on the circumstances of the particular application at hand. It is further contemplated that the size and shape of the secondary liner 26 could be equal to or larger than the lower end portion 16 of the label sheet 12 when desired.

In a preferred embodiment, depicted in FIG. 1, the adhesive shelf talker 10 is assembled to have a plurality of label sheets 12 disposed on a large liner sheet 24 in spaced relationship with one another. In this manner, a smooth, perforation-free edge portion can be provided to the label sheet 12 in an effort to enhance its appearance. Moreover, the spaced relationship of the label sheets 12 and the back cuts that define the secondary liner 26, either separately or together, greatly increases the ease and speed with which the label sheets can be separated from the liner sheet 24. However, it is contemplated that each of the plurality of liner sheets 12 could be positioned closely adjacent one another and separated using selectively-placed lines of weakness to form the peripheral edge of the individual label sheets. The large liner sheet 24 will still be preferably provided with a plurality of back cuts or lines of weakness, which define the plurality of secondary liners 26, closely adjacent the lower end portions 16 of each label sheet 12. Depending upon the printing format desired, the liner sheet 24 can be provided in a number of different forms, including a continuous sheet, separate smaller pages or sheets, continuous pin-fed sheets separated by perforated ends, and other such formats.

In one preferred embodiment, flash fusion printing is used to dispose the indicia on the forward surface 20 of the label sheet 12. The use of flash fusion requires less heat than most laser imaging and provides more material flexibility during the manufacturing and assembly process. This will provide the added benefit of a lower cost typically incurred in prior art shelf talker designs. This includes the use of the lightweight, non-curl liners, such as the polypropylene examples given previously. Such materials will hold their form and resist stretching better than the final stock that is currently being used in prior art shelf talkers. To improve impact, laser, and thermal imaging of the indicia on the forward surface 20 of the label 12, a top coating may be provided to the forward surface 20 prior to the printing of the indicia. These top coatings may be water-based, UV-cured, solvent-based, or other. The particular top coating used will depend upon the particular application, the materials being used, and the imaging technology being used. It is contemplated, for example, that the present invention lends itself easily to LED array-continuous, laser diode-continuous, direct thermal, thermal transfer, laser diode-sheeted, LED array-sheeted, or other similar imaging technologies.

In use, the adhesive shelf talker 10 of the present invention easily identifies any product in nearly any display setting. One common setting will include a display where the label sheet 12 is coupled to the forward edge portion 28 of a shelf 30, directly in front of a particular product 32. Such an example is depicted in FIG. 3. In the embodiment depicted, it is preferred that the upper end portion 14 of the label sheet 12 be shaped and sized accordingly to fit the shape and size of the shelf edge 28 from which the label sheet will depend. Where a line of weakness 18 is incorporated into the label sheet 12, it is preferred that the size and shape of the upper end portion 14 of the label sheet 12, or its location on the forward edge portion 28 of the shelf 30, be such that the line of weakness 18 be positioned adjacent the bottom of the forward edge 28. In this manner, the upper end portion 14 can display indicia relating to the product, which is less time- or promotion-sensitive than the indicia disposed on the lower end portion 16 that will typically relate to discounts, manager's promotions, “bonus buys,” and the like. Accordingly, in the example depicted in FIG. 3, the label sheet 12 is positioned on the forward edge portion 28 of the shelf 30 so that the lower end portion 16 hangs below the forward edge portion 28. The lower end portion 16 in this particular example is advertising a temporary bonus buy savings. Once the promotion has ended, the lower end portion 16 of the label sheet 12 can be easily detached from the upper end portion 14 at the line of weakness 18. This will leave the “permanent” product label (the upper end portion 14 of the label sheet 12 in this example) behind for continued identification of the particular product. The secondary liner 26 positioned on the rearward surface 22 of the lower end portion 16 will substantially prevent the lower end portion 16 from adhering unintentionally to products or adjacent structure and will further assist the user in detaching the lower end portion 16 from the upper end portion 14. It is contemplated that the secondary liner 26 will be of assistance where the shelf talker is to be used against a larger continuous surface, rather than the narrow edge of a shelf, and continue to provide a means for easily detaching the lower end portion 16 from the upper end portion 14 when the promotion is over. Moreover, the use of the secondary liner with the lower end portion 16 will fortify the lower end portion 16 as it hangs from the edge portion 28 of the shelf 30. Such fortification may be desirable when relatively thin label stock is used or the display conditions would otherwise overcome the ability of the lower end portion 16 to hang in a substantially straight fashion.

In the drawings and in the specification, there have been set forth preferred embodiments of the invention; and although specific items are employed, these are used in a generic and descriptive sense only and not for purposes of limitation. Changes in the form and proportion of parts, as well as substitution of equivalents, are contemplated as circumstances may suggest or render expedient without departing from the spirit or scope of the invention as further defined in the following claims.

Thus it can be seen that the invention accomplishes at least all of its stated objectives.

1-20. (canceled)

21. A method of identifying a product, said method comprising the steps of:
providing a label sheet having upper and lower end portions and first and second faces, said second face of said label having an adhesive provided thereon;
providing a first line of weakness formed within said label sheet extending between said upper and lower end portions and defining a line for separating said upper and lower portions;
providing a liner sheet operatively coupled to said adhesive and the second face of said label sheet;
providing a second line of weakness formed within said liner sheet to define a secondary liner that is selectively separable from said liner sheet;
removing said secondary liner from said liner sheet yet maintaining said secondary liner in contact with said label sheet;
removing said label sheet and attached secondary liner from said liner sheet;
said first face of said label sheet having product information printed thereon; and
attaching said upper portion of said label sheet to a shelf for displaying product information concerning a product.

22. A method, as claimed in claim 21, further comprising the step of:
separating said lower portion of said label sheet from said upper portion of said label sheet along said first line of weakness.

23. A method, as claimed in claim 21, wherein:
said first surface of the upper portion of said label is provided with product information relating to the product, and said first surface of the lower end portion of said label sheet is provided with promotion specific information relating to the product.

24. A method, as claimed in claim 21, wherein:
said secondary liner is formed to have a size and shape approximating a size and shape of said lower end portion of said label sheet; and
said upper end portion of said label sheet has a size approximate of a size of a width of an edge portion of a shelf.

25. A method, as claimed in claim 21, wherein:
said liner sheet is comprised of polypropylene.

26. A method, as claimed in claim 21, wherein:
said label sheet includes a plurality of label sheets, each having respective upper and lower end portions, respective first and second faces, and respective first lines of weakness separating said upper and lower end portions, said label sheets being operatively coupled to said liner sheet in spaced apart relationships with one another.

27. A method, as claimed in claim 21, wherein:
said lower end portion of said label sheet extends below said upper portion of said label sheet when said label sheet is attached to the shelf.

28. A method of identifying a product, said method comprising the steps of:
providing a label sheet having upper and lower end portions, said label sheets having product information printed on said upper end portion, and product promotion information printed on said lower end portion;
providing a liner sheet attached to said label sheet;
providing a first line of weakness defining a line separating said upper and lower end portions, and providing a second line of weakness formed within said liner sheet to define a secondary liner that is selectively separable from said liner sheet;
removing said label sheet from said liner sheet, and removing said secondary liner from said liner sheet while maintaining said secondary liner in connection with a lower end portion of the label sheet; and
securing the upper end portion of the label sheet to a product display.

29. A method, as claimed in claim 28, further including the step of:
separating the lower end portion from said upper end portion when a product promotion ends.
